(19) United States
(12) Patent Application Publication
(10) Pub. No.: US 2005/0271005 A1
(43) Pub. Date: Dec. 8, 2005

(54) CDMA network and related method using adaptive coding rate to maximize Walsh code usage

(75) Inventor: Purva R. Rajkotia, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 10/860,680

(22) Filed: Jun. 3, 2004

(51) Int. Cl. H04Q 7/00

(52) U.S. Cl. 370/329; 370/335

(57) ABSTRACT

A base station for communicating with mobile stations in a coverage area of a wireless network. The base station adapts a coding rate of user data being transmitted to a first mobile station in a forward channel (e.g. a Supplemental Channel) in order to maximize the number of Walsh codes available for use in the base station. The base station adapts the coding rate by increasing the coding rate and then transmitting the user data at the increased coding rate using a longer Walsh code. The longer Walsh code and the increased coding rate are selected in order to meet a target data rate.

### TECHNICAL FIELD OF THE INVENTION

The present invention relates generally to wireless networks and, more specifically, to a wireless network that adapts coding rates in order to maximize Walsh code usage.

### BACKGROUND OF THE INVENTION

In code division multiple access (CDMA) systems, a user data signal (e.g., digitized voice, digital IP data) is modulated (or multiplied) by a particular type of pseudo-random noise (PN) code known as a Walsh code. Multiplying the user data by the Walsh code spreads the narrow band user data signal into a wideband, spread spectrum signal. Unlike TDMA systems that divide the available spectrum into different, non-overlapping time slots, CDMA wireless networks overlap the spread spectrum signals transmitted to all users. However, each base station of a CDMA wireless network uses a unique Walsh code to modulate the forward channel data transmitted to each end-user wireless terminal (or mobile station). A CDMA mobile station is able to detect and capture forward channel signals modulated by the unique Walsh code assigned to the CDMA mobile station.

Wireless networks operating according to the CDMA2000 standard (i.e., IS-2000) are capable of transmitting in the forward channel at different data rates and using different modulation schemes. In order to avoid the costly overhead associated with negotiating data rates, frame formats, and modulation schemes with each wireless terminal (or mobile station), CDMA2000 specifies a set of predetermined channel configurations which define spreading rate, frame format, modulation scheme, and the like. For example, Radio Configuration 3 (RC3 of CDMA2000) supports data rates of 1.2 kbps, 1.35 kbps, 1.5 kbps, 2.4 kbps, 2.7 kbps, 4.8 kbps, 9.6 kbps, 19.2 kbps, 38.4 kbps, 76.8 kbps, and 153.6 kbps. An RC3 base station transmits using QPSK modulation and 20 millisecond frames. RC3 uses 64 unique Walsh codes per base station. At a data rate of 9.6 kbps, a 20 millisecond frame from an RC3 base station contains 22 bits of CRC data, 10 bits of header data and 160 bits of user data.

CDMA2000 standard wireless networks are capable of transmitting forward channel signals to mobile stations using both Fundamental Channels and Supplemental Channels. Each mobile station receives lower speed user data (e.g., voice data) on a Fundamental Channel (FCH) having a relatively low data rate (e.g., 9.6 kbps) and may receive higher speed user data (e.g., packet data) on a Supplemental Channel (SCH) having a relatively high data rate (e.g., 19.3 kbps, 38.4 kbps, 76.8 kbps, 153.6 kbps). The supplemental channels may be assigned to a mobile station on demand. Higher data rates are achieved in the supplemental channels by using shorter Walsh codes, as explained below.

As the number of mobile stations handled by a base station increases, the number of Walsh codes used increases. Walsh code usage increases by one for every voice user entering a wireless network. For data users, the current number of users being served by the packet data channel determines the increase in Walsh code usage. In a 1× CDMA wireless network (e.g., 1xEV-DV), higher rate packet data channels consume more Walsh code space. The higher the data rate supported, the greater the Walsh code usage will be. This, in turn, impacts the available number of Walsh codes. CDMA2000 adds each symbol of information to one complete Walsh code. Faster symbol rates therefore require shorter Walsh codes. If a short Walsh code is chosen to carry a fast data channel that Walsh code and all of its replicative descendants are compromised and cannot be reused to carry other signals. This is illustrated below in FIG. 2.

FIG. 2 illustrates a Walsh code tree for the forward traffic channels in a Radio Configuration 3 (RC3) embodiment of a conventional CDMA2000 wireless network. In an RC3 network, there are 64 unique Walsh codes, each containing N chips, where N may be, for example, 128 or 256. The 64 Walsh codes (WCs) are shown in row 210 and are labeled (from left to right) as WC00, WC01, WC02, . . . , WC62, WC63, WC00 is dedicated to the Pilot Channel signal. WC01 is dedicated to the Synchronization (SYNC) Channel signal. WC03 is dedicated to the Quick Paging Channel (QPCH) signal. WC32 is dedicated to Paging Channel 1. The remaining Walsh codes in row 210 are used in Fundamental Channels assigned to individual mobile stations. The 64 Walsh codes in row 210 transmit at a basic (1×) data rate, such as 9.6 kbps).

When higher data rates (2×, 4×, 8×, etc.) are needed, the shorter Walsh codes in row 220, row 230, row 240, and row 250 may be used to transmit data in a Supplemental Channel to a mobile station. Row 220 contains 32 Walsh codes that are half the length of the Walsh codes in row 210, but transmit data at a 2× data rate (i.e., 19.2 kbps). Row 230 contains 16 Walsh codes that are half the length of the Walsh codes in row 220, but transmit data at a 4× data rate (i.e., 38.4 kbps). Row 240 contains 8 Walsh codes that are half the length of the Walsh codes in row 230, but transmit data at a 8× data rate (i.e., 76.8 kbps). Row 250 contains 4 Walsh codes that are half the length of the Walsh codes in row 240, but transmit data at a 16× data rate (i.e., 153.6 kbps).

However, using shorter Walsh codes from rows 220, 230, 240 and 250 reduces the number of Walsh codes available by eliminating the replicative descendants of the shorter Walsh codes. For example, using the short Walsh code at node 221 in row 220 means that its replicative descendants, WC56 and WC57, cannot be used, since WC56 and WC57 are not orthogonal to the short Walsh code at node 221. Similarly, using the short Walsh code at node 231 in row 230 means that its replicative descendants, WC60, WC61, WC62, and WC63, and the Walsh codes on row 220 below node 231, cannot be used. Using the short Walsh code at node 241 in row 240 means that its replicative descendants, WC56-WC63, and the intermediate Walsh codes on rows 220 and 230 below node 241, also cannot be used.

Therefore, the supply of available Walsh codes in a base station sector diminishes greatly when a fast Supplemental Channel is used to transmit packet data. Thus, higher data rates and more free Walsh codes do not go together. One may be increased only at the expense of the other. As a result, there may be times when the available Walsh codes are depleted, but the system has not reached its peak in terms of power usage.

Therefore, there is a need in the art for an improved CDMA2000 wireless network that manages Walsh codes more effectively. In particular, there is a need for a CDMA2000 wireless network that can handle high speed data users with minimum impact on the number of users that may be handled.

### SUMMARY OF THE INVENTION

The present invention provides a technique for managing Walsh codes in a base station of a wireless network. The present invention uses an adaptive coding rate to increase the number of available Walsh codes without reducing the amount of data the wireless mobile station receives.

To address the above-discussed deficiencies of the prior art, it is a primary object of the present invention to provide, for use in a wireless network, a base station capable of communicating with a plurality of mobile stations in a coverage area of the wireless network. According to an advantageous embodiment, the base station is capable of adapting a coding rate of user data being transmitted to a first mobile station in a forward channel in order to maximize the number of Walsh codes available for use in the base station.

According to one embodiment of the present invention, the forward channel is a Supplemental Channel.

According to another embodiment of the present invention, the base station adapts the coding rate by increasing the coding rate.

According to still another embodiment of the present invention, the base station is further capable of transmitting the user data at the increased coding rate using a longer Walsh code.

According to yet another embodiment of the present invention, the longer Walsh code and the increased coding rate are selected in order to meet a target data rate.

According to a further embodiment of the present invention, the base station is further capable of determining whether the first mobile station is capable of receiving the user data transmitted at the increased coding rate.

According to a still further embodiment of the present invention, the base station is further capable of transmitting a control message to the first mobile station notifying the first mobile station of the increased coding rate and the longer Walsh code.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network that adapts the coding rate in the forward channel in order to maximize Walsh code usage according to the principles of the present invention;

FIG. 2 illustrates a Walsh code tree for the forward traffic channels in a Radio Configuration 3 (RC3) embodiment of a conventional CDMA2000 wireless network;

FIG. 3 is a high-level block diagram illustrating selected portions of exemplary exemplary base station according to an exemplary embodiment of the present invention; and

FIG. 4 is a flow diagram illustrating the operation of an exemplary base station according to an exemplary embodiment of the present invention.

### DETAILED DESCRIPTION OF THE INVENTION

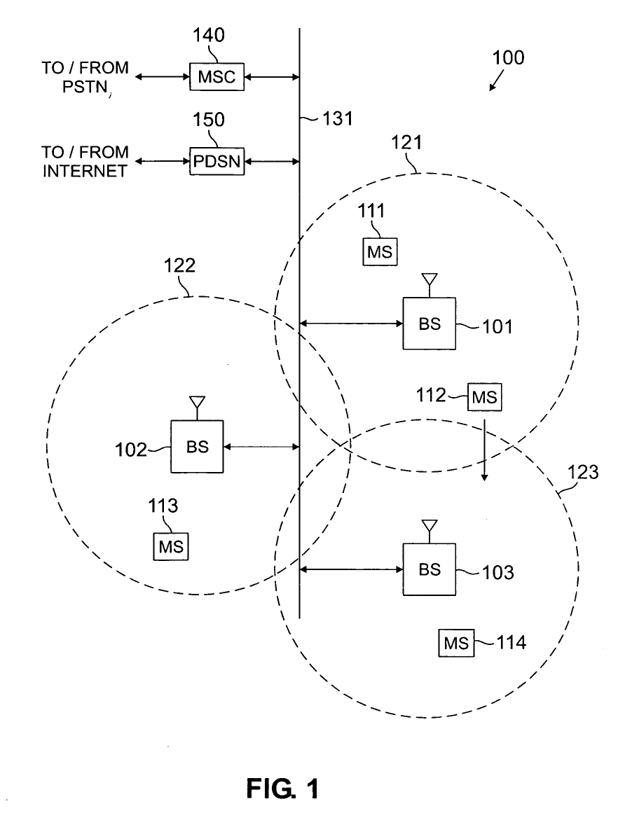

FIGS. 1 through 4, discussed herein, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100, which adapts the coding rate in the forward channel in order to maximize Walsh code usage according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

According to an exemplary embodiment, wireless network 100 operates under Radio Configuration 3 (RC3) of the CDMA2000 standard. However, this is by way of example only and should not be construed so as to limit the scope of the present invention. In other embodiments, an adaptive rate coding technique according to the principles of the present invention may be implemented in wireless networks operating under other radio configurations, such as RC4 through RC10.

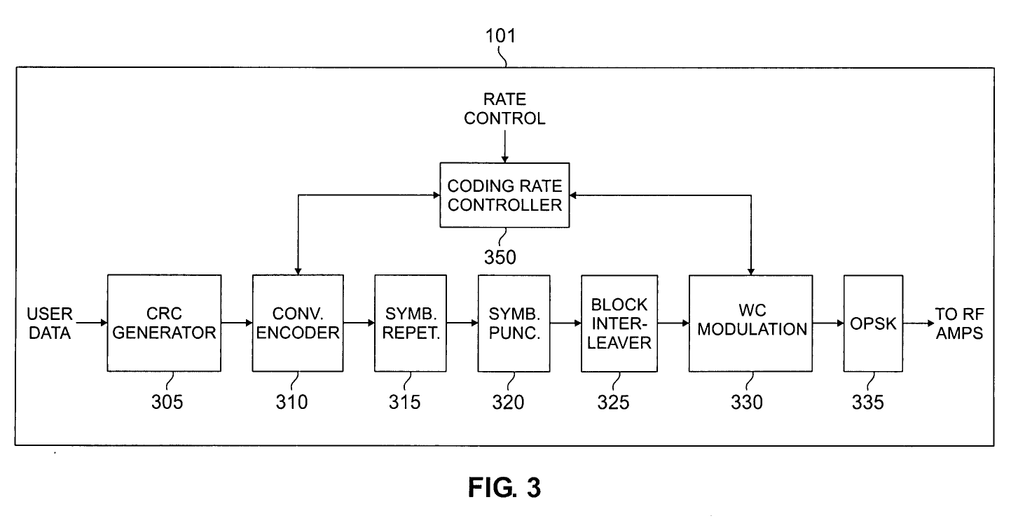

FIG. 3 is a high-level block diagram illustrating selected portions of the transmit path of exemplary base station 101 according to an exemplary embodiment of the present invention. Base station (BS) 101 comprises cyclic redundancy check (CRC) generator block 305, convolutional encoder block 310, symbol repetition block 315, symbol puncture block 320, lock interleaver block 325, Walsh code modulation block 330 and quadrature phase-shift keying (QPSK) block 335, and coding rate controller 350. The exemplary transmit path architecture depicted in FIG. 3 is, for the most part, similar to a convention CDMA2000-compatible base station transmitter. The function and operational details of most of the functional blocks shown in FIG. 3 are widely known and understood by those skilled in the art.

CRC generator block 305 receives a stream of incoming user data and adds error-checking bits that may be used in the receive path of the mobile station to correct errors in the received user data. Convolutional encoder 310 applies adaptive convolutional encoding to the output of CRC generator 305 according to control signals received from coding rate controller 350. Thus, the coding rate at the output of convolutional encoder 310 may be varied according to the principles of the present invention.

Symbol repetition block 315 repeats (2×) each of the data bits in the output of convolutional encoder 310. Symbol puncture block 320 removes some extra bits/symbols that are introduced during convolutional encoding. After puncturing, block interleaver block 325 interleaves (re-orders) the data bits in order to provide protection against burst errors. Walsh code (WC) modulation block 330 then multiplies the interleaved data by variable length Walsh codes. The Walsh code length is determined by controls signals received from coding rate controller 350. The output of WC modulation block 330 is then up-converted by QPSK 335 to a radio frequency (RF) signal. The RF signal is then amplified prior to transmission.

According to the principles of the present invention, coding rate controller 350 maximizes the Walsh Code usage in BS 101 by adjusting the coding rate of convolutional encoder block 310 to compensate for the use of shorter Walsh codes. Thus, if a mobile station requests a high-speed packet data service that requires the use of a supplemental channel that uses a shorter Walsh code, coding rate controller 350 can increase the coding rate and thereby minimize the amount of reduction in the size of the Walsh code used.

To better understand the impact of coding rate gain on the management of Walsh codes, the physical characteristics of the forward channel are now described mathematically. The relationship between the bandwidth of the forward channel and the data rate and other physical data operations may be represented by Equation 1 below:
TB=DR*CR*RF*(WC Length) Eqn. 1
where
TB=Total Bandwidth;
DR=Data Rate;
CR=Coding Rate;
RF=Repetition Factor (2×, 4×, 8×, etc.); and
WC length=Walsh Code Length

To support a 9600 bps channel, Equation 1 gives the following bandwidth value in chips per second (cps):
TB=9600*2*1*64=1,228,800 Cps (bandwidth of CDMA system).

From Equation 1, the following Equation may be easily derived:
DR=TB/(CR*RF*WC Length) Eqn. 2

Thus, the data rate (DR) is inversely proportional to the Walsh Code length and is directly proportional to the total bandwidth of the system. The present invention takes advantage of this by applying an adaptive coding rate that enables wireless network 100 to operate at a lower Walsh code length and higher data rate.

By way of example, the following example scenario is considered: a 1xEV-DV wireless network 100 reaches the Walsh code capacity limit at a 153.6 Kbps Supplemental Channel (SCH) and X number of voice users. After the channel is full to capacity, no more than X voice users may be supported. A Walsh code of length Z is required to support the 153.6 kbps Supplemental Channel. A single Walsh code is needed to support one voice user. Using an adaptive coding rate according to the principles of the present invention rate, a Walsh code of length (Z-Q) is needed to support the 153.6 Kbps packet data rate. The extra Q by which the Walsh code length is reduced is the number of free Walsh codes available for extra users. Thus, the capacity of voice users now increases from an old value of (Total Number of Walsh Codes—Z) to a new value of (Total Number of Walsh codes—Z+Q). The decrease in the usage of Walsh codes required to support the 153.6 Kbps channel may be accommodated by increasing the coding rate. Thus, increasing the coding rate has the same impact as using the larger Walsh codes. The transmission power can be adjusted to minimize the re-transmissions and achieve the best user performance.

The above operation and the increase in the capacity may be shown mathematically by inserting values in Equation 2. In a conventional wireless network, to support 153.6 Kbps Supplemental channel, the required channel parameters are:
DR=153.6 Kbps=(1.2288 Mcps)/(2*1*4),
where:
Data Rate (DR)=153.6 Kbps;
Total Bandwidth (TB)=1.2288 Mcps;
Coding Rate (CR)=2;
Repetition Factor (RF)=1; and
WC Length=4.

Using an adaptive coding rate according to the principles of the present invention, it is assumed that base station 101 adaptively selects a Coding Rate (CR) equal to 1. The selected adaptive coding rate may depend on the environment, available Walsh codes, nature of the applications to be supported, and the like. Using a Coding Rate (CR) of 1, the target Data Rate of 153.6 Kbps may be achieved with a Walsh Code (WC) length of 8. Using a Walsh code length of 8 instead of 4 increases the capacity of base station 101 by 13% in the exemplary 64 length Walsh code wireless network 100. This, in turn, means eight (8) more Walsh codes are available for use, without impacting user capacity.

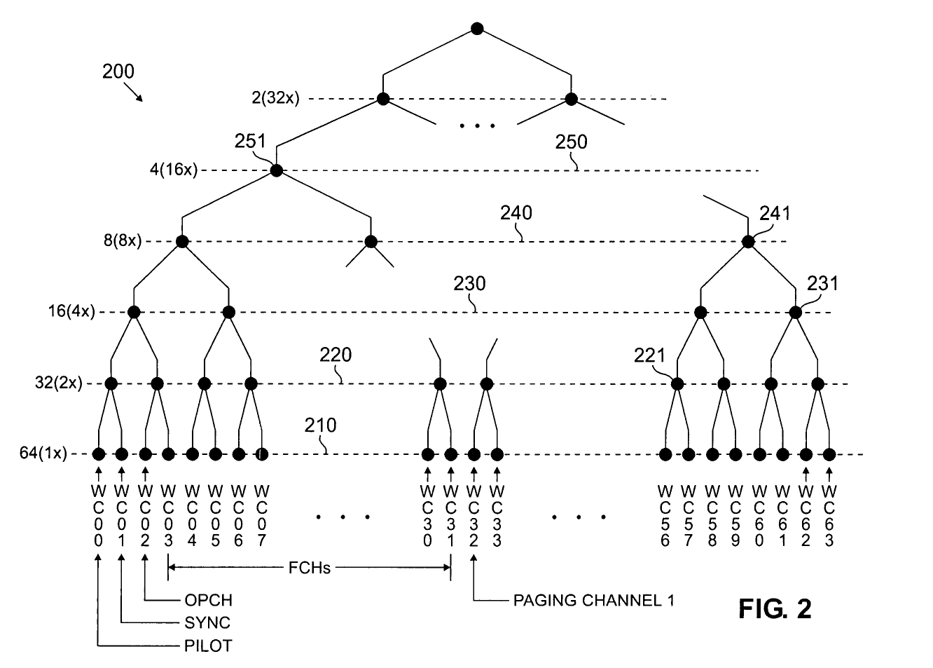

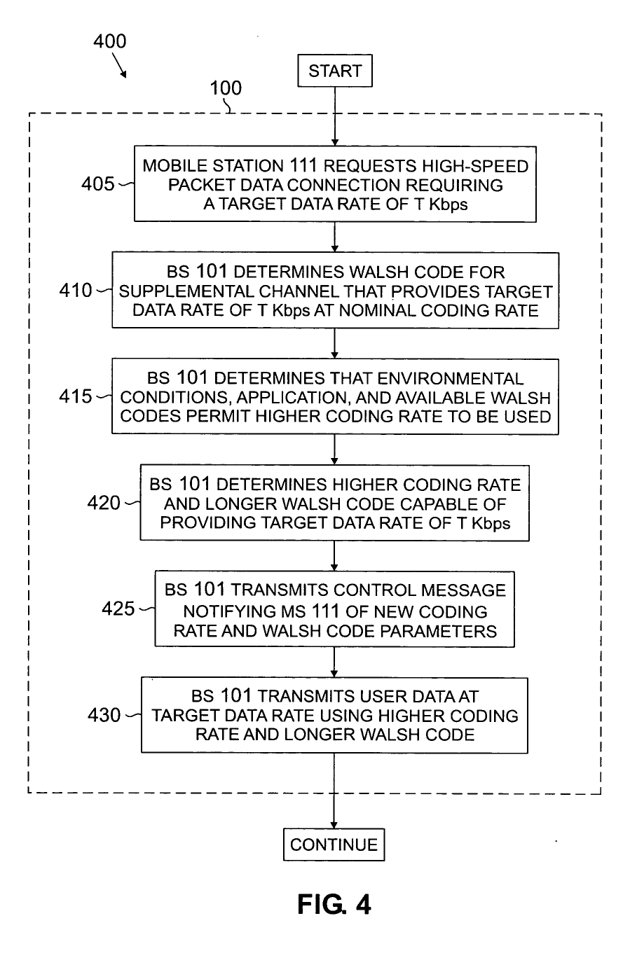

FIG. 4 depicts flow diagram 400, which illustrates the operation of exemplary base station 101 according to an exemplary embodiment of the present invention. Initially, mobile station 111 requests a high-speed packet data connection (i.e., web browsing) requiring a target data rate of T Kbps (process step 405). For example, T may equal 76.8 Kbps. In response to the request, base station (BS) 101 determines the Walsh code for a Supplemental Channel that provides the target data rate of T Kbps at the nominal coding rate for the radio configuration (process step 410). For example, the Walsh code at node 241 in FIG. 2 may support a data rate of 76.8 Kbps.

Next, BS 101 determines whether environmental conditions, the end-user application, and the available Walsh codes permit a higher coding rate than the nominal coding rate to be used (process step 415). This information may be determined from, among other things, the RSSI and bit error rates of reverse channel signals received from MS 111. BS 101 then determines a higher coding rate and a longer Walsh code capable of providing the target data rate of T kbps (process step 420). For example, BS 101 may determine that the Walsh code at node 231 in FIG. 2, coupled with a higher coding rate, is sufficient to provide the target data rate of T Kbps.

BS 101 then transmits a control message notifying MS 111 of the new higher coding rate and the new Walsh code parameters (process step 425). A Rate Control signal is sent to coding rate controller 350, which sets convolutional encoder block 310 and WC modulation block 330 to the correct parameters. BS 101 then transmits user data at the target data rate using the higher coding rate and the longer Walsh code (process step 430).

Although the present invention has been described with an exemplary embodiment, various changes and modifications may be suggested to one skilled in the art. It is intended that the present invention encompass such changes and modifications as fall within the scope of the appended claims.

1. For use in a wireless network, a base station capable of communicating with a plurality of mobile stations in a coverage area of the wireless network, wherein said base station is capable of adapting a coding rate of user data being transmitted to a first mobile station in a forward channel in order to maximize the number of Walsh codes available for use in said base station.

2. The base station as set forth in claim 1 wherein said forward channel is a Supplemental Channel.

3. The base station as set forth in claim 2 wherein said base station adapts said coding rate by increasing said coding rate.

4. The base station as set forth in claim 3 wherein said base station is further capable of transmitting said user data at said increased coding rate using a longer Walsh code.

5. The base station as set forth in claim 4 wherein said longer Walsh code and said increased coding rate are selected in order to meet a target data rate.

6. The base station as set forth in claim 5 wherein said base station is further capable of determining whether said first mobile station is capable of receiving said user data transmitted at said increased coding rate.

7. The base station as set forth in claim 6 wherein said base station is further capable of transmitting a control message to said first mobile station notifying said first mobile station of said increased coding rate and said longer Walsh code.

8. The base station as set forth in claim 6 wherein said base station determines whether said first mobile station is capable of receiving said user data transmitted at said increased coding rate based on an application being executed by said first mobile station.

9. The base station as set forth in claim 6 wherein said base station determines whether said first mobile station is capable of receiving said user data transmitted at said increased coding rate based on radio frequency conditions of said forward channel.

10. A wireless network comprising a plurality of base stations capable of communicating with a plurality of mobile stations in a coverage area of the wireless network, wherein a first one of said plurality of base stations is capable of adapting a coding rate of user data being transmitted to a first mobile station in a forward channel in order to maximize the number of Walsh codes available for use in said first base station.

11. The wireless network as set forth in claim 10 wherein said forward channel is a Supplemental Channel.

12. The wireless network as set forth in claim 11 wherein said base station adapts said coding rate by increasing said coding rate.

13. The wireless network as set forth in claim 12 wherein said base station is further capable of transmitting said user data at said increased coding rate using a longer Walsh code.

14. The wireless network as set forth in claim 13 wherein said longer Walsh code and said increased coding rate are selected in order to meet a target data rate.

15. The wireless network as set forth in claim 14 wherein said base station is further capable of determining whether said first mobile station is capable of receiving said user data transmitted at said increased coding rate.

16. The wireless network as set forth in claim 15 wherein said base station is further capable of transmitting a control message to said first mobile station notifying said first mobile station of said increased coding rate and said longer Walsh code.

17. The wireless network as set forth in claim 16 wherein said base station determines whether said first mobile station is capable of receiving said user data transmitted at said increased coding rate based on an application being executed by said first mobile station.

18. The wireless network as set forth in claim 16 wherein said base station determines whether said first mobile station is capable of receiving said user data transmitted at said increased coding rate based on radio frequency conditions of said forward channel.

19. For use in a base station of a wireless network, a method of operating the base station comprising the steps of:
receiving from a first mobile station a request for a packet data service at a target data rate;
determining a first Walsh code capable of providing the requested packet data service at the target data rate, wherein the first Walsh code is based on a standard radio configuration of the base station;
determining a first coding rate associated with the first Walsh code;
adapting the coding rate of user data being transmitted to a first mobile station in a forward channel by increasing the coding rate from the first coding rate to a second coding rate higher than the first coding rate in order to maximize the number of Walsh codes available for use in the base station.

20. The method as set forth in claim 19 further comprising the step of transmitting the user data at the increased coding rate using a longer Walsh code.

21. The method as set forth in claim 20 wherein the forward channel is a Supplemental Channel.

22. The method as set forth in claim 21 wherein the longer Walsh code and the increased coding rate are selected in order to meet a target data rate.
